(19) United States
(12) Patent Application Publication
(10) Pub. No.: US 2002/0143914 A1
(43) Pub. Date: Oct. 3, 2002

(54) Network-aware policy deployment

(76) Inventor: Joseph F. Cihula, Hillsboro, OR (US)

Correspondence Address: Jan Carol Little, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/823,190

(22) Filed: Mar. 29, 2001

(51) Int. Cl. G06F 15/173

(52) U.S. Cl. 709/223; 709/225; 709/240

(57) ABSTRACT

Network-aware policy deployment uses dynamic network information, such as topology, congestion, link bandwidth, error rates, and the like, to intelligently deploy a policy in the most efficient manner possible. Because the software determines how to deploy a policy, the software is able to map a single user-created policy onto several devices that might otherwise have required the user to create and maintain multiple policies. Moreover, the software is able to analyze and adjust the deployment based on current network conditions.

### BACKGROUND OF THE INVENTION

1. Field of the Invention

The present invention is related to communication networks and, in particular, to policy-based network management.

2. Background of the Invention

Policy-based network management is the application of policies to collections of network devices in order to manage the behavior of traffic on a network. Such policies might specify that traffic sent from a particular device should be forwarded out one interface, while all other traffic should be forwarded out another interface. A policy is a combination of actions and conditions that specify what network devices do when they encounter specific types of traffic.

Actions are the way network devices respond when traffic meets a policy's conditions. Conditions are the requirements traffic must meet before policy-enforcing devices apply the policy's action. When traffic meets all conditions defined in the policy, policy-enforcing devices apply the policy's action to the traffic. Conditions can focus a policy on measurable quantities such as time of day, specific aspects of network traffic, such as specific protocols, or specific users.

Currently, when a network administrator creates a new policy, the network administrator specifies the conditions of that policy, the actions taken when traffic meets those conditions, and the specific network devices that enforce the policy. After the network administrator creates a policy, the policy is stored in a policy server, which also stores policy information, user information, and network device information. The policy server pushes the policy to a device-specific proxy (or the device itself if it so capable), which forwards the policy to the appropriate enforcing network device. When the policy-enforcing network device detects traffic that meets all of a policy's device-related conditions, the policy-enforcing network device applies the policy's action to the traffic.

This existing methodology has a few limitations, however. For example, Current policy management software does not use network information, such as topology, to selectively deploy policies in the most efficient way possible. Instead, the network administrator is forced to explicitly specify which devices receive which policies and how to coordinate policies among all of the devices. This can lead to inefficient use of network resources, incorrect use of resources, or even failed deployment. And even if the network administrator is able to create a correct and efficient set of policies, they may be difficult to maintain as the network configuration dynamically changes.

### BRIEF DESCRIPTION OF THE DRAWINGS

The invention is best understood by reference to the figures wherein references with like reference numbers generally indicate identical, functionally similar, and/or structurally similar elements. The drawing in which an element first appears is indicated by the leftmost digit(s) in the reference number in which:

FIG. 1 is high-level block diagram of a computing environment suitable for implementing aspects of the present invention;

FIG. 2 is an alternative view of the environment of FIG. 1;

FIG. 3 is an alternative view of the environment of FIG. 1;

FIG. 4 is flowchart of a method illustrating an example approach to network aware policy deployment; and

FIG. 5 is a block diagram of an example system for implementing the deployment software.

### DETAILED DESCRIPTION OF THE ILLUSTRATED EMBODIMENTS

Network-aware policy deployment is described herein. In the following description, numerous specific details, such as particular processes, materials, devices, and so forth, are presented to provide a thorough understanding of embodiments of the invention. One skilled in the relevant art will recognize, however, that the invention can be practiced without one or more of the specific details, or with other methods, components, etc. In other instances, well-known structures or operations are not shown or described in detail to avoid obscuring aspects of various embodiments of the invention.

Some parts of the description will be presented using terms such as packets, switch, router, network, traffic, algorithm, and so forth. These terms are commonly employed by those skilled in the art to convey the substance of their work to others skilled in the art.

Other parts of the description will be presented in terms of operations performed by a computer system, using terms such as receiving, detecting, collecting, transmitting, and so forth. As is well understood by those skilled in the art, these quantities and operations take the form of electrical, magnetic, or optical signals capable of being stored, transferred, combined, and otherwise manipulated through mechanical and electrical components of a computer system; and the term “computer system” includes general purpose as well as special purpose data processing machines, systems, and the like, that are standalone, adjunct or embedded.

Various operations will be described as multiple discrete steps performed in turn in a manner that is most helpful in understanding the invention. However, the order in which they are described should not be construed to imply that these operations are necessarily order dependent or that the operations be performed in the order in which the steps are presented.

Reference throughout this specification to “one embodiment” or “an embodiment” means that a particular feature, structure, process, step, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

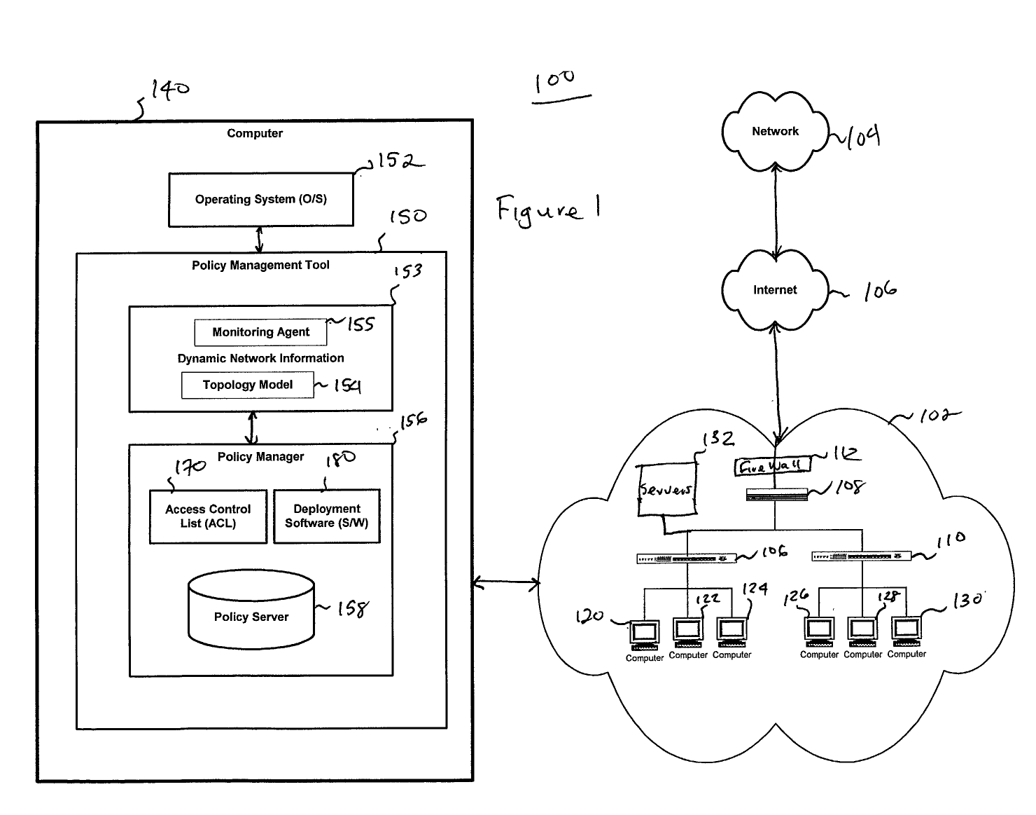

FIG. 1 is a high-level block diagram of communication environment 100 suitable for implementing aspects of the present invention. The environment 100 may be a wide area network (WAN) and include metropolitan area networks (MANs), local area networks (LANs), intranets, and/or other networks.

Traffic moves in the environment 100 in accordance with the well known Open System Interconnection (OSI) reference model, which consists of seven layers, each of which specifies particular network functions such as addressing, flow control, error control, encapsulation, and reliable message transfer. The layers are the physical layer (Layer 1), the data link layer (Layer 2), the network layer (Layer 3), the transport layer (Layer 4), the session layer (Layer 5), the presentation layer (Layer 6), and the application layer (Layer 7), which are well known.

The environment 100 includes a network 102, which may be a WAN, MAN, LAN, an intranet, or other network. The network 102 typically includes network devices such as the switch 106, the router 108, the hub 110, the firewall 112 and other network elements, such as servers 132, clients (not shown), and the like.

The switch 106 is any typical network device that filters, forwards, and floods frames based on the destination address of each frame. In one embodiment, the switch 106 operates at the network layer (Layer 3). A suitable switch for implementing the switch 106 is an Intel® NetStructure™ 480T Routing Switch available from Intel Corporation in Santa Clara, Calif.

The router 108 is any typical network layer device that uses one or more metrics to determine the optimal path along which network 102's traffic should be forwarded. In one embodiment, the router 108 forwards packets from one network to another based on network layer information. Routers such as the router 108 are occasionally called gateways. A suitable router for implementing the router 108 is a Cisco 7500 Series Router available from Cisco Systems in San Jose, Calif.

The hub 110 is any typical network device that provides Layer 2 connectivity as a single broadcast domain. A suitable hub for implementing the hub 110 is an Intel® 330T Stackable Hub available from Intel Corporation in Santa Clara, Calif.

The firewall 112 is any typical network devicedesignated as a buffer between any connected public networks and a private network for the purpose of filtering undesirable traffic. In one embodiment, the firewall 112 is a buffer between the Internet 106 and the network 102. In this embodiment, the firewall 112 monitors and sometimes restricts traffic crossing network 102's perimeters. A suitable firewall for implementing the firewall 112 is a Cisco PIX 500 Firewall available from Cisco Systems in San Jose, Calif.

The router 108, the firewall 112, and other network elements may be edge devices. An edge device is generally a physical device that is capable of forwarding packets between legacy interfaces (such as Ethernet and Token Ring) and asynchronous transfer mode (ATM) interfaces based on data-link layer (Layer 2) and network layer (Layer 3) information. The concept of “edge devices” is well known.

The environment 100 also includes a network 104, which may be similar to the network 102. For example, the network 104 may be a WAN, MAN, LAN, an intranet, or other network. Moreover, the network 104 may be more than one network.

The network 102 includes several computers 120, 122, 124, 126, 128, and 130. Users (not shown) use these computers to exchange information in the environment 100. For example, the users of the computers 120, 122, 124, 126, 128, and 130 exchange information with the network 104 via the Internet 106, which is intended to represent a broad range of public and private data networks that have hubs, routers, switches, gateways, and the like, known in the art, and not necessarily “the Internet” of common usage.

The servers 132 are intended to represent one or more servers, which are devices executing software programs that provide services including content to clients, such as the users of computers 120, 122, 124, 126, 128, and 130. Suitable servers for implementing the servers 132 are TN 3270 Servers available from Cisco Systems in San Jose, Calif.

According to an embodiment of the present invention, a network administrator uses a policy management tool 150 to administer and manage the network 102. The policy management tool is typically run on a computer such as the computer 140, which may be a personal computer, a workstation, server, or other suitable computer, in conjunction with the computer's operating system 152.

The network 104 also typically has a network administrator that performs the same or similar functions and may use such a tool. However, for clarity, only one network administrator will be described herein.

The policy management tool 150 includes dynamic network information 153. In one embodiment, the dynamic network information 153 maintains information, such as topology, error rates, response times, and the like, for the router 108, the switch 106, the hub 110, the servers 132, and links between the devices. The dynamic network information 153 continually reflects the configuration and status of the network 100 as the network 100 changes.

In one embodiment, the dynamic network information 153 includes a topology model 154. The topology model 154 in one embodiment is a mathematical model of the physical configuration of nodes and media within the network 102. A suitable model with which to implement the topology model 154 is AdventNet Web NMS available from AdventNet in Pleasanton, Calif.

In another embodiment, the dynamic network information 153 includes at least one monitoring agent 155 to monitor the performance of the network 102 and its devices (e.g., for the router 108, the switch 106, the hub 110, the servers 132, and links between the devices). In this embodiment, the monitoring agent 155 may generate statistical information about the network 102 and its devices. The monitoring agent 155 may use any well-known network management protocol to communicate within the network 102, such as the Simple Network Management Protocol (SNMP) or the remote monitoring (RMON) network management protocol. The monitoring agent 155 also may monitor the network 102 to determine the types of traffic present and the devices the traffic is passing through.

The monitoring agent 155 also may monitor traffic in the network 102 and classify the traffic. Traffic may be audio traffic, video traffic, hypertext transfer protocol (HTTP) traffic, file transfer protocol (FTP) traffic, electronic business (e-business) traffic (e.g. SAP™), database traffic (e.g., Oracle™), which are all well known, or other types of traffic.

The policy management tool 150 includes a policy manager 156, which manages the quality of service traffic receives in the environment 100 using one or more policies. A policy is a combination of actions and conditions that specify what network devices do when the network devices encounter specific types of traffic. Conditions are the requirements traffic must meet before policy-enforcing network devices apply the policy's action. Actions are the way network devices respond when traffic meets a policy's conditions. The policy manager 156 specifies (with network administrator input) a policy's conditions, the action taken when traffic meets those conditions, and the network devices that enforce the policy. A suitable policy manager for implementing the policy manager 156 is an Intel® NetStructure™ Policy Manager v1.0 available from Intel Corporation in Santa Clara, Calif.

The policy manager 156 includes a policy server 158, which stores policies, policy information, user information, and network device information. In one embodiment, the policy server 158 “pushes” a policy to proxies, which forward the policy to the appropriate enforcing devices. A “proxy” allows a device to act as a surrogate for a service that is not available locally. The policy server may retrieve policies from a repository (not shown).

According to an embodiment of the present invention, the policy management tool 150 prevents the users of the computers 120, 122, 124, 126, 128, and 130 from accessing the network 104 under certain circumstances. For example, the network administrator can prohibit the users of the computers 120, 122, 124, 126, 128, and 130 from accessing the files on the network 104 via the Internet 105 using FTP. Traditionally, the network administrator would apply a policy at the firewall 110 to prohibit all users from accessing the network 104 using FTP. However, this means that FTP request packets will traverse the entire network 102 before being rejected by the firewall 110.

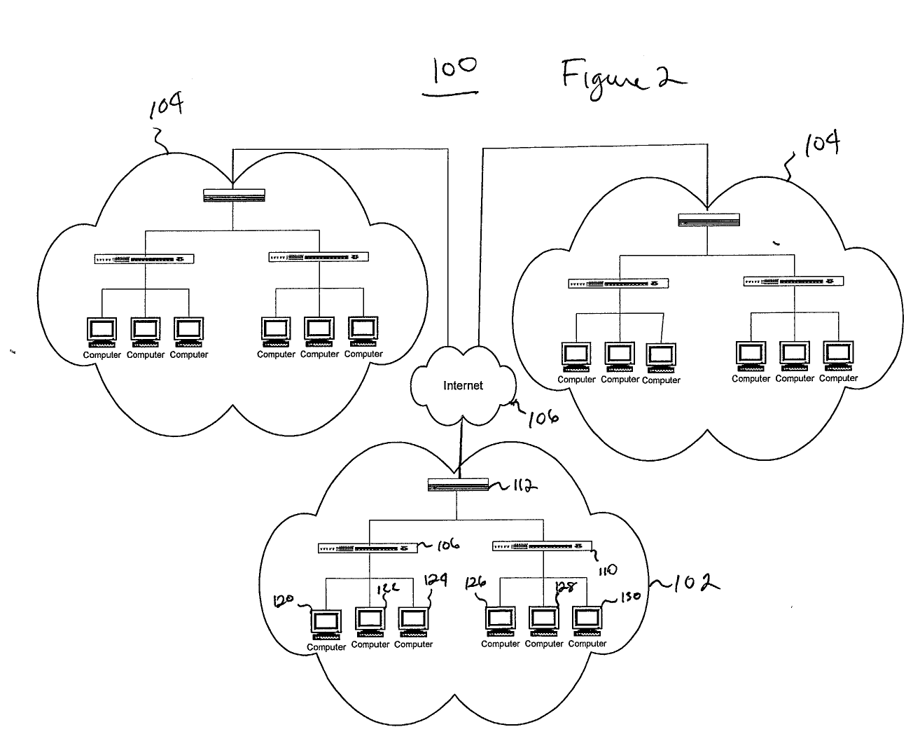

In one embodiment, the policy management tool 150 uses the dynamic network information 153 to generate a policy to block traffic at multiple points, such as the policy manageable devices closest to source of the traffic, in the network 102 based on a topology-based analysis of the network 102. The policy management tool 150 maps the traffic-blocking policy to the switch 106 and to the router 108. The policy management tool 150 maps a traffic-blocking policy to the switch 106 to prevent the users of the computers 120, 122, and 124 from accessing the network 104 via the Internet 105 using FTP. Similarly, transmission control protocol (TCP), or other traffic can be blocked. According to the embodiment shown in FIG. 2, the hub 110 is not a policy-enforcing device. As such the policy manager 156 maps the policy the router 108 to prevent the users of the computers 126, 128, and 130 from accessing the network 104 via the Internet 106 using FTP. In one embodiment, the policy manager 156 applies an access control list (ACL) 170 to the switch 106 and the router 108 to prevent the users from accessing the network 104.

Of course, other traffic may be prohibited as well. For example, in an embodiment, the policy manager 156 maps a gaming policy to appropriate network devices to block traffic to/from gaming servers, such as a Quake® server, during business hours.

Because the choice of deployment targets, e.g., the switch 106 and the router 108, is made automatically based inputs from the topology model 154, the choice of deployment targets will maintain itself if the topology should change. For instance, if the hub 110 were upgraded to a policy-enforcing device, such as a switch, the policy manager 156 automatically deploys the traffic-blocking policy to the new switch.

For purposes of illustration and referring to FIG. 2, which shows the environment 100 in more detail, suppose the network 102 is a LAN and the network 104 is a WAN. According to an embodiment of the present invention, the policy management tool 150 uses the dynamic network information 153 to prioritize traffic classifications across the network 102 (the computers 120, 122, 124, 126, 128, and 130, the switch 106, and the router 108) and preserves that prioritization across the boundaries of the network 104. The policy manager 156 deploys a priority policy, which assigns different priorities (prioritizes) to specific types (or classification) of traffic. When a network device encounters traffic (comprised of packets) that matches the policy's conditions, the device adds a priority tag to the packet, which is a logical grouping of information that includes a header containing control information. Packets, which are another logical grouping of information, tagged with a high priority are processed through devices' high priority queues and packets tagged with a low priority are processed through devices' low priority queues. For example, time-critical and mission-critical data may be tagged with a high priority while e-mail and non-critical file transfers are tagged “best-effort.”

Often, traffic in the network 104 travels over non-Ethernet media, which results in Ethernet Layer 2 packet prioritization information that was present in the traffic packets on the network 102 being lost when that traffic is routed over the network 104. Likewise, traffic from the network 104 with asynchronous transfer mode (ATM) or Internet Protocol (IP) (Layer 3) prioritization information might not be completely usable in the network 102 (perhaps due to equipment capabilities).

Traditionally, the network administrator has to maintain not only the prioritization tags in the various individual network 102 devices (e.g. computers, switches, routers), but also has to provide network 102-to-network 104 priority translation tagging at the network 104 boundaries (e.g. routers). As the network 102 topology changes and traffic classification changes the network administrator has to maintain the tags synchronized.

In one embodiment, the policy management tool 150 uses the dynamic network information 153 to maintain the relationships between traffic classification and priority markers for both the network 102 devices and the network 104 devices. For example, the policy management tool 150 uses the dynamic network information 153 to determine which devices are on the network 104 boundaries (edge devices, such as routers). The policy management tool 150 generates a policy to tag certain traffic going to a set of edge devices in the network 102 with translation markers. In effect, the policy management tool 150 generates a policy to prioritize certain types of traffic. The policy automatically selects the prioritization mechanism based on the protocol and/or media the traffic traverses. The policy management tool 150 maps the policy to the set of edge devices to prioritize the traffic through the devices such that the relationships between traffic classification and priority markers for both the network 102 devices and the network 104 devices is maintained.

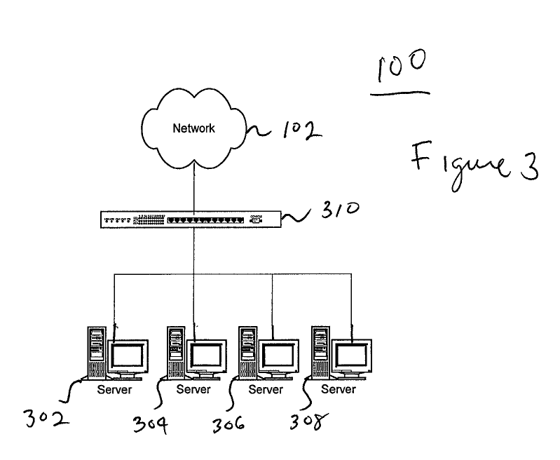

For purposes of illustration and referring to FIG. 3, which is an alternative view of the environment 100, suppose the computer 140 has monitoring agents or devices that collect statistics and data about the network 102. According to an embodiment of the present invention, the policy management tool 150 uses these statistics and data to make decisions regarding where and what types of policies to deploy in the network 102. The policy management tool 150 also may use the statistics and data to trigger certain actions that maintain policy parameters/invariants.

For example, businesses in the network 104 providing content (e.g. Web pages, FTP files, etc.) to the network 102 via a Web switch 310 often measure the quality of the end-user experience by the response time of the content (the time taken for the content to be made available to the end-user). While not all aspects of the total response time can be controlled (e.g., the portion due to latency in the Internet or user premises), for heavily used sites, a significant component of the total response time is due to the time spent in the businesses network (or service provider's network if outsourced or hosted). One reason for delay is that of congestion in the servers providing the content. That is, those servers (often multiple servers contain the same content and are connected to load balancers (which may exist in switches or other types of network devices) to distribute the overall load amongst them) may not have the capacity to provide content to all requests at the rate required to meet some specified response time metric.

Traditionally, a network administrator increases the number of servers available to provide the content. When this process is done manually, it usually takes some time before a problem is detected. It usually takes even longer before the new server can be brought up and made available. This process is also inefficient because the new server will be dedicated to that content only, even when demand is low.

In one embodiment, the policy management tool 150 uses the dynamic network information 153 to generate a policy that specified a response time metric and a set of auxiliary servers, such as servers 302, 304, and 306, that could be used to satisfy the response time metric. These auxiliary servers may contain additional content. The policy management tool 150 monitors the content response time of a main server 308 and compares the response time to the specified response time metric. If the policy management tool 150 detects that the main server 308 response time metric is not being met, the policy management tool 150 replicates the content of the main server 308 onto one of the auxiliary servers 302, 304, and/or 306 that was not being utilized (or not fully utilized). The policy management tool 150 adds that server to the load balancing rotation for this content. Once the metric is being met and low load is detected, the auxiliary server 302, 304, and/or 306 may be used to meet other content's response times. In one embodiment, the switch 310 is an ACEdirector Web Switch available from Alteon in San Jose, Calif.

For businesses that either cannot afford to have redundant servers or cannot afford to have enough servers to meet capacity requirements and still provide redundancy, server failures can be catastrophic. Either the content and applications of the failed server become unavailable or their performance becomes unacceptable. Traditionally, a network administrator would require that backup of servers' content be made and an empty server is available for that content. When a failure occurs, the network administrator restores the failed server's content to the backup server and connects the backup server in place of the failed server. This process is very time consuming.

In one embodiment, the policy management tool 150 uses the dynamic network information 153 to generate a policy that restores the failed server's content to the backup server as soon as the policy management tool 150 detected the failure. For example, the policy management tool 150 monitors the health of one server. If the server's performance becomes unacceptable, the policy management tool 150 copies the content of the unacceptable server to a new server and configures the new server to emulate the failed server. The content may be copied from the failing server or from another location that maintains a copy of the content.

For purposes of illustration and referring back to FIG. 1, suppose the network 102 has different types of traffic, which is typical. According to an embodiment of the present invention, the policy management tool 150 uses the dynamic network information 153 to generate a policy to buffer, queue, and/or prioritize network 102 traffic based on traffic type based on an analysis of the traffic found on various portions of the network 102.

For example, different types of network traffic often require different buffering/queuing and priority treatment to provide optimal “experience” for each of the different traffic types. For instance, audio is often relatively small amounts of data but requires very low latency and low loss. Video is usually very large amounts of data that requires low latency but can tolerate loss. Web traffic can vary in data size but is not sensitive to latency and losses can occur.

Traditionally, a network administrator optimizing the queuing and buffering characteristics of the network first determines what types of traffic are actually present. The network administrator must then determine the appropriate strategies for each traffic type. Finally, the network administrator must implement these strategies on the network devices individually, each of which may implement slightly differently (e.g., two queues versus eight queues, types of prioritization, buffering algorithms, etc.). Moreover, not all portions of the network 102 carry all traffic types, so optimal deployment of these configurations would require careful attention to the sources and destinations of traffic as well as to the topology of the network.

In one embodiment, the policy management tool 150 uses the dynamic network information 153 to generate a policy to queue network traffic based on priority. For example, the policy management tool 150 specifies the queuing, buffering, and prioritization rules for different traffic types. The policy management tool 150 monitors the network 102 to determine what traffic types are actually present and which portions of the network 102 the traffic of each type was using. The policy management tool 150 maps the policy to affected devices to selectively configure the devices accordingly. The traffic may be queued in the devices based on priority.

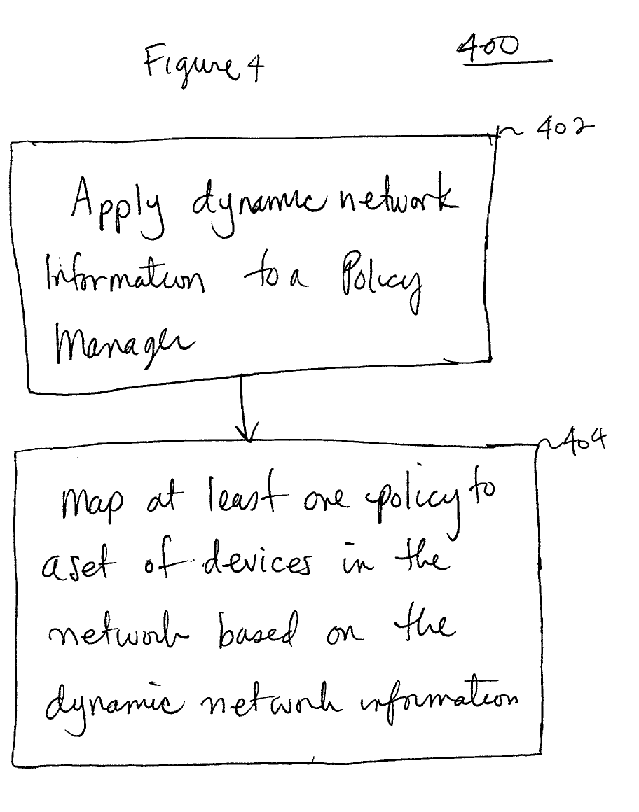

The policy manager also includes network-aware policy deployment software 180 to perform many of the functions described herein. In one embodiment, the software 180 is instructions stored on a machine-readable medium such that when executed cause a processor such as the computer 140 or other computer to perform the method 400 described with reference to FIG. 4. The method 400 illustrates an approach to using dynamic network information to selectively map a policy onto a set of devices in the network 102. The dynamic network information may include network topology, network statistical information, or network traffic information.

In step 402 applies dynamic network information to a policy manager. Step 404 maps a policy to a set of devices in the network. The policy may block traffic at edge devices in the network. The policy may queue traffic in devices in the network based on priority. The policy may tag traffic in the network based on type of traffic. The policy may monitor response time of content transfer between at least two devices in the network. The policy may monitor failure of devices in the network. The policy may control traffic through edge devices in the network. The policy may replicate content of a first device to a second device when the content response time of the first device exceeds a predetermined metric. The policy may selectively configure a set of devices based on traffic types to the set of devices. The policy may replicate content of a first device to a second device when the first device experiences a fault and to configure the second device to appear to be the first device.

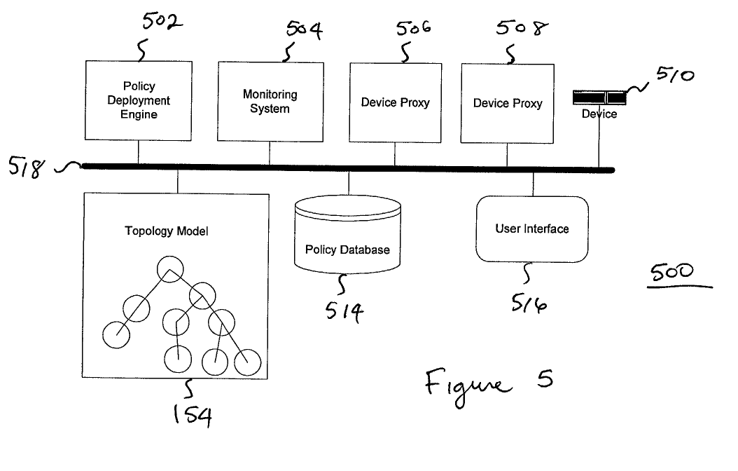

FIG. 5 is a block diagram of an example system 500 for implementing the deployment software 180. For example, the system 500 includes a policy deployment engine 502, a monitoring system 504, device proxies 506 and 508, a device 510, the topology model 154, a policy database 514, a user interface 516, and a bus 518.

The policy deployment engine 502 typically exchanges messages with network devices (e.g., switches and routers). The policy deployment engine 502 typically includes conventional circuitry for transmitting and receiving messages across network links.

The monitoring system 504 may include any well-known network management application that utilizes probes or agents to track and analyze traffic, and to gather statistics in a network. In one embodiment, the monitoring system 504 includes the monitoring agent 155.

The device proxies 506 and 508 typically are any well-known agents that act on behalf of devices in a network. In one embodiment, the device proxies 506 and 508 perform SNMP functionality for devices in the networks 102, 104, or 106.

The device 510 is intended to represent any number of devices in the networks 102, 104, or 106. For example, the device 510 may be the switch 106 or the router 108.

The policy database 514 is intended to represent one or more repositories for storing policies. The policy database 514 is typically coupled to the policy server 158.

The user interface 516 is intended to represent one or more typically graphical user interfaces (GUI), which run on a computer display and are viewable and operable by a user (e.g., a network administrator). Alternatively, the user interface 516 may be any other device, firmware, software, etc., that enables a user to implement the functionalities described herein.

The bus 518 is intended to represent an interprocess communication system (IPC), which permits the policy deployment engine 502, the monitoring system 504, the device proxies 506 and 508, the device 510, the topology model 154, and the policy database 514 to offer services to and receive services from each other.

Although various embodiments are described with respect to a local area network, the present invention is not so limited. Aspects of the invention can be implemented using hardware, software, or a combination of hardware and software. Such implementations include state machines, a field programmable gate array (FPGA), a microprocessor, an application specific integrated circuit (ASIC), discrete medium scale integrated (MSI) circuits, analog circuitry, etc. In implementations using software, the software may be stored on a computer program product (such as an optical disk, a magnetic disk, a floppy disk, etc.) or a program storage device (such as an optical disk drive, a magnetic disk drive, a floppy disk drive, etc.), which may run on general purpose computing platforms such as a UNIX platform, a Windows® platform, or a Windows® NT platform. Those skilled in the art will appreciate that a variety of platforms may be used when implementing the present invention, including specific-purpose platforms such as routers, or other products.

The above description of illustrated embodiments of the invention is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description.

What is claimed is:

1. A policy management tool, comprising:
dynamic network information; and
a policy manager coupled to the model to manage deployment of at least one policy to a set of devices in a network based on the dynamic network information.

2. The tool of claim 1 wherein the policy manager comprises a policy to restrict certain types of traffic at multiple points within the network via a topology-based analysis of the network.

3. The tool of claim 1 wherein the policy manager comprises a policy to queue, buffer, or prioritize certain types of traffic at multiple points within the network based on an analysis of traffic found on various portions of the network.

4. The tool of claim 1 wherein the policy manager comprises a policy to prioritize traffic, wherein the policy automatically selects the prioritization mechanism based on the protocol and/or media the traffic traverses.

5. The tool of claim 1 wherein the policy manager comprises a policy to monitor response time of content transfer between one or more primary servers and a device in the network and replicate content of the primary servers to at least one other server when the content response time of a primary server exceeds a predetermined metric.

6. The tool of claim 1 wherein the policy manager comprises a policy to monitor the performance of one or more primary servers and replicate content of the primary servers to at least one other server when the performance metrics of a primary server exceed a predetermined value.

7. The tool of claim 1 wherein the policy manager comprises a policy to monitor the health of one or more primary servers in the network, to replicate content of the primary servers to at least one other server when a primary server experiences a fault, and to configure the other server to emulate the primary server.

8. The tool of claim 1 wherein the policy manager creates access control lists to control traffic through edge devices in the network based on a topology analysis of the network.

9. The tool of claim 1 wherein the dynamic network information comprises a network topology, network statistical information, or network traffic information.

10. The tool of claim 1 wherein the policy manager comprises a policy to replicate content of a first device to a second device when the content response time of the first device exceeds a predetermined metric.

11. The tool of claim 1 wherein the policy manager comprises a policy to selectively configure a set of devices based on an analysis of the traffic processed by the set of devices.

12. The tool of claim 1 wherein the policy manager comprises a policy to replicate content of a first device to a second device when the first device experiences a fault and to configure the second device to emulate the first device.

13. A method, comprising:
applying dynamic network information to a policy manager; and
mapping a policy to a set of devices in the network based on the dynamic network information.

14. The method of claim 13 wherein the policy manager comprises a policy to restrict certain types of traffic at multiple points within the network via a topology-based analysis of the network.

15. The method of claim 13 wherein the policy manager comprises a policy to queue traffic in devices in the network based on priority.

16. The method of claim 13 wherein the policy manager comprises a policy to buffer traffic in devices in the network based on priority.

17. The method of claim 13 wherein the policy manager comprises a policy to prioritize traffic in the network based on type of traffic.

18. The method of claim 13 wherein the policy manager comprises a policy to monitor response time of content transfer between one or more primary servers and a device in the network and replicate content of the primary servers to at least one other server when the content response time of a primary server exceeds a predetermined metric.

19. The method of claim 13 wherein the policy manager comprises a policy to monitor the performance of one or more primary servers and replicate content of the primary servers to at least one other server when the performance metrics of a primary server exceed a predetermined value or to monitor the performance of one or more primary servers and replicate content of the primary servers to at least one other server when the performance metrics of a primary server exceed a predetermined value.

20. The method of claim 13 wherein the policy manager comprises an access control list to control traffic through edge devices in the network.

21. The method of claim 13 wherein the dynamic network information comprises a network topology, network statistical information, or network traffic information.

22. The method of claim 13 wherein the policy manager comprises a policy to replicate content of a first device to a second device when the content response time of the first device exceeds a predetermined metric.

23. The method of claim 13 wherein the policy manager comprises a policy to selectively configure a set of devices based on traffic types to the set of devices.

24. The method of claim 13 wherein the policy manager comprises a policy to replicate content of a first device to a second device when the first device experiences a fault and to configure the second device to emulate the first device.

25. An apparatus, comprising:
a machine-readable medium having stored thereon instructions for causing a processor to:
apply dynamic network information to a policy manager; and
map a policy to a set of devices in the network based on the topology of the network.

26. The apparatus of claim 25 wherein the instructions are further to cause the processor to apply a policy to restrict certain types of traffic at multiple points within the network via a topology-based analysis of the network.

27. The apparatus of claim 25 wherein the instructions are further to cause the processor to apply a policy to queue traffic in devices in the network based on priority.

28. The apparatus of claim 25 wherein the instructions are further to cause the processor to apply a policy to tag or prioritize traffic in the network based on type of traffic.

29. The apparatus of claim 25 wherein the instructions are further to cause the processor to apply a policy to response time of content transfer between one or more primary servers and a device in the network and replicate content of the primary servers to at least one other server when the content response time of a primary server exceeds a predetermined metric.

30. The apparatus of claim 25 wherein the policy manager further comprises a policy to monitor the performance of one or more primary servers and replicate content of the primary servers to at least one other server when the performance metrics of a primary server exceed a predetermined value or to monitor the performance of one or more primary servers and replicate content of the primary servers to at least one other server when the performance metrics of a primary server exceed a predetermined value.
